(19) United States
(12) Patent Application Publication
(10) Pub. No.: US 2024/0234732 A1
(43) Pub. Date: Jul. 11, 2024

(54) ELECTRODE AND SOLID-STATE BATTERY

(71) Applicant: Toyota Jidosha Kabushiki Kaisha, Toyota-shi (JP)

(72) Inventors: Heidyhodex VISBALMENDOZA, Nagoya-shi (JP); Toru Kidosaki, Miyoshi-shi (JP)

(73) Assignee: Toyota Jidosha Kabushiki Kaisha, Toyota-shi (JP)

(21) Appl. No.: 18/531,016

(22) Filed: Dec. 6, 2023

(30) Foreign Application Priority Data
Jan. 10, 2023 (JP) 2023-001930

(51) Int. Cl. H01M 4/62; H01M 10/0562

(52) U.S. Cl. CPC H01M 4/62; H01M 10/0562; H01M 2004/021; H01M 2300/0068

(57) ABSTRACT

An electrode includes: an active material which is a positive electrode active material or a negative electrode active material; and an electrode layer containing a solid electrolyte that includes a solid electrolyte SEa having a particle size that is greater than or equal to 0.7 μm and less than or equal to 2.0 μm and a solid electrolyte SEb having a particle size that is greater than or equal to 1/10 and less than or equal to ⅕ of the particle size of the solid electrolyte SEa, wherein, in a ³¹P-MAS-NMR spectrum of the solid electrolyte, a proportion of a peak intensity of 78 ppm with respect to a sum of the peak intensity of 78 ppm and a peak intensity of 83.7 ppm is greater than or equal to 2.4% and less than or equal to 7%, and a solid-state battery including the electrode.

### CROSS-REFERENCE TO RELATED APPLICATION

This application is based on and claims priority under 35 USC 119 from Japanese Patent Application No. 2023-001930 filed on Jan. 10, 2023, the disclosure of which is incorporated by reference herein.

### BACKGROUND

### Technical Field

The present disclosure relates to an electrode and a solid-state battery.

### Related Art

In solid-state batteries that use an electrode having a solid electrolyte, the resistance value of the solid-state battery may increase after repeated charging and discharging.

As a solution to this phenomenon, International Publication (WO) No. 2007/004590 proposes “an all-solid-state battery using a lithium-ion conductive solid electrolyte as an electrolyte, wherein the lithium-ion conductive solid electrolyte is mainly composed of sulfides and the surface of the positive electrode active material is coated with a lithium-ion conductive oxide.

### SUMMARY

A problem to be solved by an exemplary embodiment of the present disclosure is to provide an electrode in which an increase in the resistance value of a solid-state battery after repeated charging and discharging is suppressed.

A problem to be solved by another exemplary embodiment of the present disclosure, is to provide a solid-state battery in which an increase in the resistance value after repeated charging and discharging is suppressed.

### Means for Solving the Problem

Means for solving the above-described problems include the following means.

<1> An electrode including: an active material which is a positive electrode active material or a negative electrode active material; and an electrode layer containing a solid electrolyte that includes a solid electrolyte SEa having a particle size that is greater than or equal to 0.7 μm and less than or equal to 2.0 μm and a solid electrolyte SEb having a particle size that is greater than or equal to 1/10 and less than or equal to ⅕ of the particle size of the solid electrolyte SEa, wherein, in a ³¹P-MAS-NMR spectrum of the solid electrolyte, a proportion of a peak intensity of 78 ppm with respect to a sum of the peak intensity of 78 ppm and a peak intensity of 83.7 ppm is greater than or equal to 2.4% and less than or equal to 7%.

<2> The electrode according to <1>, wherein a volume of the solid electrolyte with respect to a total volume of the active material and the solid electrolyte is greater than or equal to 20% by volume and less than or equal to 40% by volume.

<3> The electrode according to <1> or <2>, wherein a content of the solid electrolyte SEb with respect to a content of the solid electrolyte is greater than or equal to 5% by mass and less than or equal to 20% by mass.

<4> The electrode according to an one of <1> to <3>, wherein: in a Raman spectrum of the solid electrolyte, a peak derived from a PS4 structure is present at greater than or equal to 423 cm⁻¹ and less than or equal to 425 cm⁻¹; and a half width of the peak derived from the PS4 structure is greater than or equal to 6 and less than or equal to 9.5.

<5> A solid-state battery including the electrode according to any one of <1> to <4>.

According to an exemplary embodiment of the present disclosure, there is provided an electrode in which an increase in the resistance value of a solid-state battery after repeated charging and discharging is suppressed.

According to another exemplary embodiment of the present disclosure, there is provided a solid-state battery in which an increase in the resistance value after repeated charging and discharging is suppressed.

### DETAILED DESCRIPTION

Hereinafter, exemplary embodiments, which are examples of the present disclosure, will be described. These descriptions and examples are intended to illustrate exemplary embodiments and do not limit the scope of the present disclosure.

In numerical value ranges that are expressed in a stepwise manner in the present disclosure, the upper limit value or the lower limit value described in a given numerical value range may be replaced with the upper limit value or the lower limit value of another numerical value range that is expressed in a stepwise manner. Further, in the numerical ranges described in the present disclosure, the upper limit value or the lower limit value described in a given numerical range may be replaced with a value shown in the examples.

Each component in the present disclosure may contain plural substances of interest.

In the present disclosure, when referring to the amount of each component in a composition, in a case in which there are plural types of substances that correspond to each component in the composition, unless otherwise specified, the amount of each component means the total amount of plural types of substances in the component.

In the present disclosure, the term “step” includes not only an independent step, but also a step that cannot be clearly distinguished from another step as long as the intended operation of the step is achieved.

### <Electrode>

An electrode according to the present disclosure has an electrode layer that contains an active material which is a positive electrode active material or a negative electrode active material, and a solid electrolyte including a solid electrolyte SEa having a particle size that is greater than or equal to 0.7 μm and less than or equal to 2.0 μm and a solid electrolyte SEb having a particle size that is greater than or equal to 1/10 and less than or equal to ⅕ of the particle size of the solid electrolyte SEa, and in a ³¹P-MAS-NMR spectrum of the solid electrolyte, a proportion of a peak intensity of 78 ppm with respect to the sum of the peak intensity of 78 ppm and a peak intensity of 83.7 ppm is greater than or equal to 2.4% and less than or equal to 7%.

According to the above-described configuration, the electrode according to the present disclosure is an electrode in which an increase in the resistance value of a solid-state battery after repeated charging and discharging is suppressed. The reason for this is presumed to be as follows.

By the solid-state electrode containing a solid electrolyte including the solid electrolyte SEa having a particle size that is greater than or equal to 0.7 μm and less than or equal to 2.0 μm and the solid electrolyte SEb having a particle size that is greater than or equal to 1/10 and less than or equal to ⅕ of the particle size of the solid electrolyte SEa, the filling ratio of the solid electrolyte contained in the electrode is improved. As a result, the conduction paths of the lithium ions are increased.

Furthermore, in the ³¹P-MAS-NMR spectrum of the solid electrolyte, by the proportion of the peak intensity of 78 ppm with respect to the sum of the peak intensity of 78 ppm and the peak intensity of 83.7 ppm being greater than or equal to 2.4% and less than or equal to 7%, a highly crystalline high-ionic conductive phase (PS4) is obtained.

An electrode according to the present disclosure is a positive electrode or a negative electrode.

In a case in which the electrode according to the present disclosure is a positive electrode, the active material is a positive electrode active material. Further, in a case in which the electrode according to the present disclosure is a positive electrode, the electrode layer is also referred to as a positive electrode layer.

In a case in which the electrode according to the present disclosure is a negative electrode, the active material is a negative electrode active material. Further, in a case in which the electrode according to the present disclosure is a negative electrode, the electrode layer is also referred to as a negative electrode layer.

### (Electrode Layer)

The electrode layer according to the present disclosure contains an active material which is a positive electrode active material or a negative electrode active material, and a solid electrolyte including a solid electrolyte SEa having a particle size that is greater than or equal to 0.7 μm and less than or equal to 2.0 μm and a solid electrolyte SEb having a particle size that is greater than or equal to 1/10 and less than or equal to ⅕ of the particle size of the solid electrolyte SEa.

The electrode layer may contain a conductive agent, a binder, and other components, as necessary.

### —Active Material—

The electrode layer according to the present disclosure contains an active material which is a positive electrode active material or a negative electrode active material.

### Positive Electrode Active Material

The positive electrode active material preferably contains a lithium complex oxide.

The lithium complex oxide may contain at least one selected from the group consisting of F, Cl, N, S, Br, and I. Further, the lithium complex oxide may have a crystal structure belonging to at least one space group selected from the space groups R-3m, Immm or P63-mmc (also referred to as P63mc, P6/mmc). At the lithium complex oxide, the main sequence of a transition metal, oxygen and lithium may be an 02-type structure.

### Negative Electrode Active Material

Examples of the negative electrode active material include lithium-based active materials such as metallic lithium, carbon-based active materials such as graphite, oxide-based active materials such as lithium titanate, and Si-based active materials such as Si alone.

### —Solid Electrolyte—

The electrode according to the present disclosure contains a solid electrolyte including a solid electrolyte SEa having a particle size that is greater than or equal to 0.7 μm and less than or equal to 2.0 μm, and a solid electrolyte SEb having a particle size that is greater than or equal to 1/10 and less than or equal to ⅕ of the particle size of the solid electrolyte SEa.

### Solid Electrolyte SEa

The particle size of the solid electrolyte SEa is greater than or equal to 0.7 and less than or equal to 2.0 μm, preferably greater than or equal to 0.8 μm and less than or equal to 1.5 μm, and more preferably greater than or equal to 0.9 and less than or equal to 1.2 μm.

The particle size of the solid electrolyte SEa is measured by LASER diffraction method. A specific measurement procedure is as follows.

The average particle size is measured by LASER diffraction method using a MALVERN Mastersizer 2000, and is calculated from the volume-based average particle size. Specifically, using a Mastersizer 2000 manufactured by Malvern Instruments Ltd., 110 ml of dehydrated toluene (Wako Pure Chemical Industries, Ltd.; product name: Special Grade) was charged into the dispersion tank of an apparatus, and further, 6% of dehydrated tertiary butyl alcohol (Wako Pure Chemical Corporation; Special Grade) was added as a dispersant. After thoroughly mixing the mixture, the solid electrolyte SEa was added and the particle size was measured.

The solid electrolyte SEa preferably contains a sulfide solid electrolyte.

As the sulfide solid electrolyte, sulfur (S) is preferably contained as a main component of the anionic element, and more preferably, the sulfide solid electrolyte contains, for example, the element Li, an element A, and the element S. The element A is at least one selected from the group consisting of P, As, Sb, Si, Ge, Sn, B, Al, Ga, and In. The sulfide solid electrolyte may further contain at least one of O or a halogen element. Examples of the halogen element (X) include F, Cl, Br, 1, and the like. The composition of the sulfide solid electrolyte is not particularly limited, and examples include xLi2S·(100−x)P₂S₅ (70≤x≤80) and yLiI·zLiBr·(100-y-z)(xLi₂S·(1-x)P₂S₅) (0.7≤x≤0.8, 0≤y≤30, 0≤z≤30). The sulfide solid electrolyte may have a composition represented by the following general formula (1).

Li₄₋ₓGe₁₋ₓPₓS₄(0<x<1) Formula (1):

In Formula (1), at least a part of Ge may be substituted with at least one selected from the group consisting of Sb, Si, Sn, B, Al, Ga, In, Ti, Zr, V, and Nb. Further, at least a part of P may be substituted with at least one selected from the group consisting of Sb, Si, Sn, B, Al, Ga, In, Ti, Zr, V, and Nb. A part of Li may be substituted with at least one selected from the group consisting of Na, K, Mg, Ca, and Zn. A part of S may be substituted with halogen. The halogen is at least one of F, Cl, Br, or I.

### Solid Electrolyte SEb

The particle size of the solid electrolyte SEb is greater than or equal to 1/10 and less than or equal to ⅕ of the particle size of the solid electrolyte SEa, preferably greater than equal to 1/50 and less than or equal to ½ of the particle size of the solid electrolyte SEa, more preferably greater than or equal to 1/20 and less than or equal to ¼ of the particle size of the solid electrolyte SEa, and still more preferably greater than or equal to ⅙ and less than or equal to 1/15 of the particle size of the solid electrolyte SEa.

The particle size of the solid electrolyte SEb is measured by the same procedure as the procedure for measuring the particle size of the solid electrolyte SEa described above.

The solid electrolyte SEb preferably contains a sulfide solid electrolyte. Specific examples of the sulfide solid electrolyte are the same as those described above.

### ³¹P-MAS-NMR Spectrum of Solid Electrolyte

In the electrode according to the present disclosure, in the ³¹P-MAS-NMR spectrum of the solid electrolyte, the proportion of the peak intensity of 78 ppm with respect to the sum of the peak intensity of 78 ppm and the peak intensity of 83.7 ppm is greater than or equal to 2.4% and less than or equal to 7%, preferably greater than or equal to 1% and less than or equal to 15%, more preferably greater than or equal to 1% and less than or equal to 10%, and still more preferably greater than or equal to 1% and less than or equal to 3%.

The ³¹P-MAS-NMR spectrum of the solid electrolyte was obtained using an NMR measuring device. As the NMR measuring device, for example, AVANCE III 600 manufactured by Bruker Corporation can be used. The measurement procedure is as follows.

The solid electrolyte was extracted from the electrode layer contained in the electrode by dissolving the electrode layer in a solvent. 200 mg of the extracted solid electrolyte and the measuring solvent were added to NMR tubes, and a ³¹P-MAS-NMR spectrum was obtained by the NMR measuring device. NMR measurement conditions were as described below. In the obtained ³¹P-MAS-NMR spectrum, the peak intensity of 78 ppm and the peak intensity of 83.7 ppm were read, and the proportion of the peak intensity of 78 ppm with respect to the sum of the peak intensity of 78 ppm and the peak intensity of 83.7 ppm was calculated.

### NMR Measurement Conditions

Observed frequency: 242.94 MHz
Observation width: 250 kHz
Measurement method: Single-pulse method
Flip angle: 900 pulse
Repeat wait time: 5 times or more of the Ti
Probe: 4.0 mm
MAS rotation speed: 15 kHz
Chemical Shift Reference Material: 85% Phosphoric Acid Solution

### Raman Spectrum of the Solid Electrolyte

In the electrode according to the present disclosure, in the Raman spectrum of the solid electrolyte, it is preferable that a peak derived from the PS4 structure is present at greater than or equal to 423 cm⁻¹ and less than or equal to 425 cm⁻¹, and that a half width of the peak derived from the PS4 structure is greater than or equal to 6 and less than or equal to 9.5.

The half width of the peak derived from the PS4 structure is more preferably greater than or equal to 6.5 and less than or equal to 9.2, still more preferably greater than or equal to 7.0 and less than or equal to 8.5, and particularly preferably greater than or equal to 7.5 and less than or equal to 8.0.

Here, the PS4 structure means a structure which is a highly ionic conductive phase.

The Raman spectrum of the solid electrolyte is obtained using a Raman spectrometer. As the Raman spectrometer, for example, a DXR3xi Raman Imaging Microscope manufactured by Thermo Fisher Scientific Inc. can be used. The measurement procedure is as follows.

The solid electrolyte was extracted by cutting out the electrode layer contained in the electrode. The extracted solid electrolyte was made a measurement target, and a Raman spectrum of the solid electrolyte was obtained by a Raman spectrometer. The measurement conditions were as described below. From the obtained Raman spectrum, a peak derived from the PS4 structure was detected, and it was observed whether or not the peak top of the peak was greater than or equal to 423 cm⁻¹ and less than or equal to 425 cm⁻¹. Furthermore, the half width of the peak derived from the PS4 structure was calculated.

### Measurement Conditions

Laser energy: 1.5 mW
Exposure time: greater than or equal to 50 Hz and less than or equal to 100 Hz
Number of scans: 100

### —Conductive Agent, Binder, and Other Components—

Examples of the conductive agent include carbon materials, metal materials, and conductive polymer materials.

Examples of the binder include vinyl halide resins, rubbers, polyolefin resins, and the like.

Examples of the other components include oxide solid electrolytes, halide solid electrolytes, thickeners, surfactants, dispersants, wetting agents, antifoaming agents, and the like.

### —Content of Various Components—

From the viewpoint of resistance, the volume of the solid electrolyte with respect to the total volume of the active material and the solid electrolyte is preferably greater than or equal to 20% by volume and less than or equal to 40% by volume, more preferably greater than or equal to 22% by volume and less than or equal to 38% by volume, and still more preferably greater than or equal to 25% by volume and less than or equal to 35% by volume.

From the viewpoint of resistance, the content of the solid electrolyte SEb with respect to the content of the solid electrolyte is preferably greater than or equal to 5% by mass and less than or equal to 20% by mass, more preferably greater than or equal to 7% by mass and less than or equal to 15% by mass, and still more preferably greater than or equal to 8% by mass and less than or equal to 12% by mass.

### (Current Collector)

The electrode according to the present disclosure preferably has a current collector.

The current collector is a positive electrode current collector or a negative electrode current collector.

In a case in which the electrode according to the present disclosure is a positive electrode, the current collector is a positive electrode current collector. In a case in which the electrode according to the present disclosure is a negative electrode, the current collector is a negative electrode current collector.

### —Positive Electrode Current Collector—

The positive electrode current collector carries out current collection of the positive electrode layer. Examples of the positive electrode current collector include stainless steel, aluminum, copper, nickel, iron, titanium, carbon, and the like, and aluminum alloy foil or aluminum foil is preferable.

### —Negative Electrode Current Collector—

The negative electrode current collector carries out current collection of the negative electrode layer. Examples of the negative electrode current collector include stainless steel, aluminum, copper, nickel, iron, titanium, carbon, and the like, and copper is preferable. Examples of the form of the negative electrode current collector are the form of a foil and the form of a mesh.

### <Solid-State Battery>

The solid-state battery according to the present disclosure includes the electrode according to the present disclosure.

From the viewpoint of resistance, the solid-state battery according to the present disclosure preferably includes the electrode according to the present disclosure as a positive electrode.

It is preferable that the solid-state battery according to the present disclosure includes a positive electrode, a negative electrode, and an electrolyte layer disposed between the positive electrode and the negative electrode.

An example of the layered structure of the solid-state battery according to the present disclosure includes: positive electrode current collector/positive electrode layer/electrolyte layer/negative electrode layer/negative electrode current collector.

It is preferable that the positive electrode according to the present disclosure is applied as the positive electrode.

The negative electrode preferably has a negative electrode layer and a negative electrode current collector, and the negative electrode layer contains a negative electrode active material and a solid electrolyte, and may contain a conductive agent, a binder, and other components as necessary. The negative electrode active material, the conductive agent, the binder, and the other components which are contained in the negative electrode layer are the same as those described above. Furthermore, the solid electrolyte contained in the negative electrode layer preferably contains one selected from the group consisting of sulfide solid electrolytes, oxide solid electrolytes, and halide solid electrolytes.

The electrolyte layer may be a layer containing a solid electrolyte. When the layer contains a solid electrolyte (solid electrolyte layer), the solid electrolyte layer preferably contains one selected from the group consisting of sulfide solid electrolytes, oxide solid electrolytes, and halide solid electrolytes. The solid electrolyte layer may contain a binder, or may not contain a binder. As the binder which can be contained in the solid electrolyte layer, the same binder as the binder described above is applied.

### <Method for Manufacturing the Solid-State Battery>

A method for manufacturing the solid-state battery according to the present disclosure includes:
a step (preparation step) of preparing a positive electrode, a negative electrode, and an electrolyte layer; and
a step (layering step) of layering the positive electrode, the electrolyte layer, and the negative electrode, in this order.

### (Preparation Step)

The preparation step is a step of preparing a positive electrode, a negative electrode, and an electrolyte layer or a separator.

The method of manufacturing the positive electrode, the negative electrode, and the electrolyte layer is not particularly limited, and it is preferable to obtain a slurry by kneading the components which can be contained in the above-described positive electrode layer, negative electrode layer, and electrolyte layer, then apply the slurry to a substrate, and press the dried film obtained by drying.

Examples of the method of pressing the dried film include roll pressing, cold isostatic pressing (CIP), and the like.

### (Layering Step)

The layering step is a step of layering the positive electrode, the electrolyte layer or the separator, and the negative electrode, in this order.

In the layering step, it is preferable to layer the positive electrode, the electrolyte layer or the separator, and the negative electrode, which are prepared in the preparation step, in this order, and press them if necessary to obtain a layered structure (electrode body).

It is preferable to prepare the solid-state battery according to the present disclosure via the above steps.

### EXAMPLES

Although examples are described below, the present disclosure is not limited to these examples in any way. In the following descriptions, unless otherwise specified, “parts” are all based on mass.

### Example 1

### (Preparation Step)

### —Preparation of the Positive Electrode—

Butyl butyrate, a 5% by mass butyl butyrate solution of a polyvinylidene fluoride-based binder, vapor-grown carbon fibers (VGCF) as a conductive agent, and a sulfide solid electrolyte (an LiI-containing Li₂S—P₂S₅ glass ceramic, particle size=0.8 μm), which is the solid electrolyte SEa, were added to a kneading container of a fill-mix device (Model 30-L manufactured by PRIMIX Corporation), and the mixture was stirred at 20,000 rpm for 30 minutes.

The positive electrode active material (LiNi_{0.33}Co_{0.33}Mn_{0.33}O₂) and the two types of solid electrolytes, that is, the solid electrolyte SEa and the solid electrolyte SEb, having different particle sizes were charged into the kneading container, and stirred at 15,000 rpm for 60 minutes in the fill-mix device. Thereafter, it was coated on Al foil by a blade method using an applicator. The coated electrode was dried naturally, and then dried on a hot plate at 100° C. for 30 minutes. Thereafter, the resultant was punched into a size of 1 cm² to obtain a positive electrode.

### —Preparation of the Negative Electrode—

A sulfide solid electrolyte (an LiI-containing Li₂S—P₂S₅ glass ceramic, particle size=0.8 μm), 1% by mass of vapor grown carbon fibers (VGCF) as a conductive agent, 2% by mass of butadiene rubber as a binder, and heptane were charged into a kneading container of a fill-mix device (Model 30-L manufactured by PRIMIX Corporation), and the mixture was stirred at 20,000 rpm for 30 minutes.

Next, the negative electrode active material (Li₄Ti₅O₁₂ particles, particle size=1 μm) was charged into the kneading container such that a volume ratio of the negative electrode active material and the sulfide solid electrolyte was 7:3, and the mixture was stirred in the fill-mix device at 15,000 rpm for 60 minutes to prepare a negative electrode mixture. The prepared negative electrode mixture was coated on copper foil, and dried at 100° C. for 30 minutes. Thereafter, the mixture was punched into a size of 1 cm² to obtain a negative electrode.

### —Preparation of the Electrolyte Layer—

64.8 mg of a sulfide solid electrolyte (an LiI-containing Li₂S—P₂S₅ glass ceramic, particle size=2.5 μm) was placed into a cylindrical ceramic having an inner diameter cross-sectional area of 1 cm², and after smoothing, pressed at 1 ton/cm² to form an electrolyte layer.

### (Layering Step)

The positive electrode, the electrolyte layer, and the negative electrode were layered in this order to obtain a laminate. Note that the positive electrode was layered such that the positive electrode layer faced the electrolyte layer, and the negative electrode was layered such that the negative electrode layer faced the electrolyte layer, and a laminate was thereby obtained. The laminate was pressed at 6 ton/cm² for 1 minute. Next, a stainless steel rod was placed in the positive electrode and the negative electrode and restrained at 1 ton to obtain a solid-state battery.

### Example 2

A solid-state battery was obtained in the same manner as in Example 1, except that the addition amount of the sulfide solid electrolyte, which is the solid electrolyte SEb, was changed in the —Preparation of the Positive Electrode— of (Preparation Step).

### Example 3

A solid-state battery was obtained in the same manner as in Example 1, except that the addition amount of the sulfide solid electrolyte, which is the solid electrolyte SEb, was changed in the —Preparation of the Positive Electrode— of (Preparation Step).

### Example 4

A solid-state battery was obtained in the same manner as in Example 1, except that the addition amount of the sulfide solid electrolyte, which is the solid electrolyte SEb, was changed in the —Preparation of the Positive Electrode— of (Preparation Step).

### Example 5

A solid-state battery was obtained in the same manner as in Example 1, except that the particle size and the addition amount of the sulfide solid electrolyte, which is the solid electrolyte SEb, were changed in the —Preparation of Positive Electrode— of (Preparation Step).

### Comparative Example 1

A solid-state battery was obtained in the same manner as in Example 1, except that the solid electrolyte SEb was not added in the —Preparation of the Positive Electrode— of (Preparation Step).

### Comparative Example 2

A solid-state battery was obtained in the same manner as in Example 1, except that in the —Preparation of the Positive Electrode— of (Preparation Step), the positive electrode active material and the solid electrolyte SEa were weighed so that the volume ratio of the positive electrode active material:the solid electrolyte SEa=8:2, and the solid electrolyte SEb was not added.

### Comparative Example 3 and Comparative Example 4

Solid-state batteries were obtained in the same manner as in Example 1, except that in the —Preparation of Positive Electrode— of (Preparation Step), the solid electrolyte SEb was not added and the particle size of the solid electrolyte SEa was changed.

### Comparative Example 5 and Comparative Example 6

Solid-state batteries were obtained in the same manner as in Example 1, except that the particle sizes of the solid electrolyte SEa and the solid electrolyte SEb were changed.

### Comparative Example 7

A solid-state battery was obtained in the same manner as in Example 1, except that the particle size of the solid electrolyte SEa and the addition amount of the solid electrolyte SEb were changed.

### Comparative Example 8, Example 6, and Example 7

Solid-state batteries were obtained in the same manner as in Example 1, except that the particle sizes of the solid electrolyte SEa and the solid electrolyte SEb were changed.

### <Evaluation>

(Resistance Value Evaluation after Continuous Discharging and Charging)

The solid-state batteries obtained in each example were activated under the following activation conditions.

### Activation Conditions

CCCV charging: 0.333 C to 0.01 C cut Upper limit 2.95 V
CCCV discharging: 0.333 C to 0.01 C cut Lower limit 1.5 V

After activation, discharging and charging were performed for a total of 200 cycles with a discharge and a charge being one cycle (the voltage range was greater than or equal to 1.5 V and less than or equal to 2.95 V, and performed under the conditions of 60° C.). Thereafter, discharging was performed from a state of charge of 40%, and the voltage change when a current value of 2.5 C rate was passed was read, and the resistance value (unit: Ω) was calculated from Ohm's law. The ratio of the measured resistance value to the initial resistance was calculated.

Using the prepared solid-state batteries, 1,000 cycles of CCCV charging and discharging with an upper limit voltage of 4.55 V and a lower limit voltage of 2.5 V were performed at 0.1 C. The design capacity of the solid-state batteries was 0.3 Ah. Battery resistance was calculated from the results obtained. The initial resistance was the resistance after 3 cycles.

The resistance increase rate was calculated by the following formula.

Resistance Increase Rate(%)=((Battery Resistance after 1,000 Cycles−Initial Resistance)/Initial Resistance)×100

### (Filling Ratio of the Positive Electrode Layer)

The filling ratio of the positive electrode layer in the solid-state battery obtained in each example was measured by the following procedure.

The mass and film thickness of the 1 cm² positive electrode obtained as described above were measured, the mass and film thickness of the Al foil were subtracted, and then the density of the positive electrode layer was calculated, and the ratio of the calculated density of the positive electrode layer with respect to the true density of the designed positive electrode layer was defined as the filling ratio.

TABLE 1

| | | | | | | | | | Evaluation | |
|---|---|---|---|---|---|---|---|---|---|---|
| | | | | | | | | | Resistance | |
| | | | | | | | | | Value | |
| | Solid Electrolyte | | | | | | | | Evaluation | Filling |
| | | | | | | Peak Derived | | | after | Ratio |
| | Solid | | | | | from PS4 | | | Continuous | of |
| | Electrolyte | Solid Electrolyte SEb | | Particle | Proportion of | Structure of | | | Discharging | Positive |
| | SEa | Particle | Content (% by mass) | Size | Peak Intensity | Kaman Spectrum | | SE/SE + | and | Electrode |
| | Particle | Size | with respect to Total | Ratio | of 78 ppm | Peak Position | Half | AM | Charging | Layer |
| | Size (μm) | (μm) | Solid Electrolyte | (SEb/SEa) | (%) | (cm [symbol] ) | Width | (vol %) | (%) | (%) |
| Example 1 | 0.8 | 0.1 | 5 | 0.125 | 2.4 | 424.468 | 7.637 | 30 | 14 | 91.9 |
| Example 2 | 0.8 | 0.1 | 10 | 0.125 | 3.9 | 423.482 | 8.543 | 30 | 13.2 | 92.3 |
| Example 3 | 0.8 | 0.1 | 15 | 0.125 | 5.1 | 423.795 | 8.833 | 30 | 16.5 | 92.4 |
| Example 4 | 0.8 | 0.1 | 20 | 0.125 | 6.2 | 423.384 | 9.100 | 30 | 21 | 92.5 |
| Exarople 5 | 0.8 | 0.3 | 5 | 0.375 | 2.4 | 424.468 | 7.637 | 20 | 24.3 | 89 |
| Comparative | 0.8 | — | 0 | — | 1.3 | 424.585 | 6.994 | 30 | 25.4 | 90 |
| Exarople 1 | | | | | | | | | | |
| Comparative | 0.8 | — | 0 | — | 1.3 | 424.585 | 6.994 | 20 | 32.7 | 86 |
| Example 2 | | | | | | | | | | |
| Comparative | 0.1 | — | 0 | — | within a range | 417.9 | 12.397 | 30 | 32 | 93 |
| Example 3 | | | | | of 2.4 to 7 | | | | | |
| Comparative | 2.0 | — | 0 | — | within a range | 424.585 | 6.994 | 30 | 38 | 81 |
| Exarople 4 | | | | | of 2.4 to 7 | | | | | |
| Comparative | 1.4 | 0.08 | 5 | 0.0571 | within a range | 424.468 | 7.137 | 30 | 27.2 | 92.3 |
| Example 5 | | | | | of 2.4 to 7 | | | | | |
| Comparative | 0.7 | 0.2 | 5 | 0.2857 | within a range | 424.468 | 7.637 | 30 | 26.5 | 91.9 |
| Example 6 | | | | | of 2.4 to 7 | | | | | |
| Comparative | 0.7 | 0.1 | 3 | 0.1429 | 2.1 | 424.468 | 7.637 | 30 | 25.6 | 91.7 |
| Example 7 | | | | | | | | | | |
| Comparative | within a | 0.08 | 5 | within a | 8.5 | 424.468 | 7.637 | 30 | 27.4 | 86.5 |
| Example 3 | range of | | | range of | | | | | | |
| | 0.7 to 2.0 | | | 1/10 to 1/5 | | | | | | |
| Example 6 | 1.1 | 0.1 | 5 | 0.0909 | within a range | 424.585 | 6.994 | 30 | 17.1 | 89.7 |
| | | | | | of 2.4 to 7 | | | | | |
| Example 7 | 0.8 | 0.2 | 5 | 0.25 | within a range | 424.468 | 7.637 | 20 | 16.3 | 89 |
| | | | | | of 2.4 to 7 | | | | | |

[symbol]

indicates data missing or illegible when filed

The descriptions in Table 1 will be explained.

“Content (% by mass) with respect to Total Solid Electrolyte” described in the lower column of the Solid Electrolyte SEb means the content of the solid electrolyte SEb with respect to the content of the solid electrolyte.

“Particle Size Ratio (SEb/SEa)” means the ratio of the particle size of the solid electrolyte SEb with respect to the particle size of the solid electrolyte SEa.

“Proportion of Peak Intensity of 78 ppm” means the proportion of the peak intensity of 78 ppm with respect to the sum of the peak intensity of 78 ppm and the peak intensity of 83.7 ppm in the ³¹P-MAS-NMR spectrum of the solid electrolyte.

“SE/SE+AM (vol %)” means the volume of the solid electrolyte with respect to the total volume of the active material and the solid electrolyte.

From the above results, it can be seen that the electrode of the present embodiment is an electrode in which an increase in the resistance value of a solid-state battery after repeated charging and discharging is suppressed.

What is claimed is:

1. An electrode comprising:
an active material which is a positive electrode active material or a negative electrode active material; and
an electrode layer containing a solid electrolyte that includes a solid electrolyte SEa having a particle size that is greater than or equal to 0.7 μm and less than or equal to 2.0 μm and a solid electrolyte SEb having a particle size that is greater than or equal to 1/10 and less than or equal to ⅕ of the particle size of the solid electrolyte SEa,
wherein, in a ³¹P-MAS-NMR spectrum of the solid electrolyte, a proportion of a peak intensity of 78 ppm with respect to a sum of the peak intensity of 78 ppm and a peak intensity of 83.7 ppm is greater than or equal to 2.4% and less than or equal to 7%.

2. The electrode according to claim 1, wherein a volume of the solid electrolyte with respect to a total volume of the active material and the solid electrolyte is greater than or equal to 20% by volume and less than or equal to 40% by volume.

3. The electrode according to claim 1, wherein a content of the solid electrolyte SEb with respect to a content of the solid electrolyte is greater than or equal to 5% by mass and less than or equal to 20% by mass.

4. The electrode according to claim 1, wherein:
in a Raman spectrum of the solid electrolyte, a peak derived from a PS4 structure is present at greater than or equal to 423 cm⁻¹ and less than or equal to 425 cm⁻¹; and
a half width of the peak derived from the PS4 structure is greater than or equal to 6 and less than or equal to 9.5.

5. A solid-state battery comprising the electrode according to claim 1.
